(19) United States
(12) Patent Application Publication
(10) Pub. No.: US 2009/0072975 A1
(43) Pub. Date: Mar. 19, 2009

(54) TRACKING MODULE WITH GLOBAL POSITIONING SYSTEM FOR CARGO AND GOODS

(75) Inventor: Paul R. Arguin, Andover, MA (US)

Correspondence Address: MCCORMICK, PAULDING & HUBER LLP, CITY PLACE II, 185 ASYLUM STREET, HARTFORD, CT, 06103, US

(73) Assignee: UNITED SECURITY APPLICATIONS ID, INC., E. WINDSOR, NJ (US)

(21) Appl. No.: 12/208,825

(22) Filed: Sep. 11, 2008

Related U.S. Application Data
(60) Provisional application No. 60/993,598, filed on Sep. 13, 2007.

(51) Int. Cl. G08B 13/14

(52) U.S. Cl. 340/572.1

(57) ABSTRACT

An integrated radio frequency identification system includes a locking assembly affixed to a shipping container and a tracking module having a RFID device in electrical communication with the locking assembly. The tracking module includes integrated GPS components enabling communication with GPS satellites. A machine readable computer software and terminal assembly is provided and is capable of communication with the RFID device via one of a plurality of communication protocols. The computer software and terminal assembly is capable of generating a transit map of a location and status of the tracking module over a predetermined time period, thus graphically depicting a historical transit path of the tracking module.

### CROSS REFERENCE TO RELATED APPLICATIONS

This application claims the benefit of U.S. Provisional Application Ser. No. 60/993,598, filed on Sep. 13, 2007, and herein incorporated by reference in its entirety.

### FIELD OF INVENTION

The present invention relates to locks for sealing containers used in transporting cargo or goods generally, or people, via truck/trailer, train, ship, manual means, or otherwise. The invention utilizes any pin-style seal lock, but one which incorporates an attached module that includes RFID which is active, passive, semi-active, or semi-passive; as well as incorporating GPS (Global Positioning System), Cellular Technology which can be, for example but not limited to, GSM (Global System for Mobile Communications), CDMA (Code Division Multiple Access) or other technologies, and GPRS (General Packet Radio Service).

### BACKGROUND OF THE INVENTION

Cargo locks (such as pin-style locks) for containers and other large transportation vessels are typically used in shipping or transport operations. These known locks are mechanical locks which do not have any electronics and are employed by shipping companies to seal the container or vessel against unauthorized intrusion. Most of these locks are utilized to provide a means for the owner of the contents to ascertain if the cargo housing carrying the contents has been breached or tampered with.

That is, known pin-style (or, ‘bolt-style’) locks are capable of indicating whether they have been previously opened, as such locks typically must be permanently marred or otherwise destroyed in order to separate the various portions of the lock. As such, it is the physical state of the lock which indicates whether it has been opened, and therefore, whether the goods within the container or vessel may have been tampered with.

RFID devices have been known to be integrated with pin-style locks, and provide a means for electronically communicating with any such seal/lock, during those times when the seal is interrogated by a reader having the appropriate or matching communication protocol.

Also known are GPS systems which communicate with satellites and are typically used to determine the exact location of the GPS receiver.

For its part, GSM is the dominant technology used around the globe, currently available in more than 100 countries, for mobile/cellular communication. It is the standard for communication for most of Asia and Europe. GSM allows for simultaneous calls on the same radio frequency and uses “narrowband” TDMA, the technology that enables digital transmissions between a mobile phone and a base station. With TDMA the frequency band is divided into multiple channels which are then stacked together into a single stream, hence the term narrowband. This technology allows several callers to share the same channel at the same time.

GPRS is a Mobile Data Service available to users of (GSM). GPRS can be used for services such as Wireless Application Protocol (WAP) access, Short Message Service (SMS), Multimedia Messaging Service (MMS), and for Internet communication services such as email and World Wide Web.

With the forgoing problems and concerns in mind, it is the general object of the present invention to provide tracking module with global positioning system for cargo and goods which is capable of interfacing with a dedicated software system so as to provide for accurate tracking, status and security information, as desired.

### SUMMARY OF THE INVENTION

It is an object of the present invention to provide a single universal tracking module.

It is another object of the present invention to provide a single universal tracking module that is capable of communicating with a plurality of known communication protocols.

It is another object of the present invention to provide a single universal tracking module that is capable of communicating with a plurality of known communication protocols and which attaches to any pin-style cargo security lock.

It is another object of the present invention to provide a single universal tracking module that is integrated with a dedicated software system.

It is another object of the present invention to provide a single universal tracking module that is integrated with a dedicated software system.

It is another object of the present invention to provide a single universal tracking module that is integrated with a dedicated software system to provide for accurate tracking, status and security information, as desired.

It is another object of the present invention to provide a single universal tracking module that is integrated with a dedicated software system for interactive mapping and information retrieval.

These and other objectives of the present invention, and their preferred embodiments, shall become clear by consideration of the specification, claims and drawings taken as a whole.

### BRIEF DESCRIPTION OF THE DRAWINGS

FIG. 1 is a schematic illustration of a universal tracking module, in accordance with one embodiment of the present invention.

FIG. 2 graphically depicts the universal tracking module as part of an overall software system used to provide for accurate tracking, status, mapping and security information.

FIG. 3 illustrates the universal tracking module of FIG. 1, as integrated with a pin-style locking device.

### DETAILED DESCRIPTION OF THE INVENTION

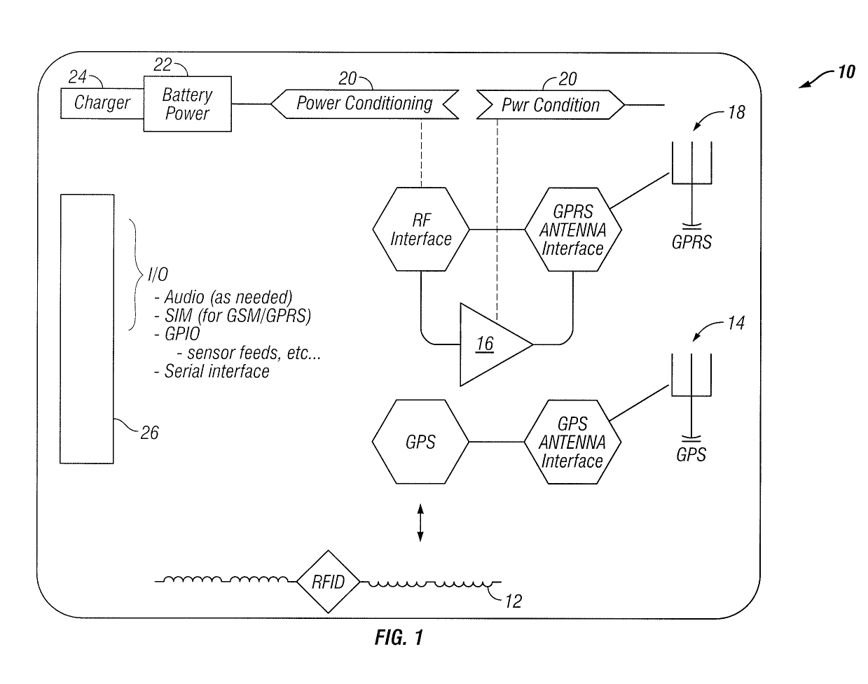

As shown in FIG. 1, a single universal tracking module 10 includes a plurality of integrated components, which are capable of interfacing with a plurality of known communication protocols. As will be discussed in more detail later, the universal tracking module 10 may itself be integrated with any known pin-style cargo security lock.

The preferred components of the universal tracking module 10 include a RFID device 12, which may be either active, passive, semi-active, or semi-passive, as is known in the art. Also included are a GPS device and antenna array 14, and additional cellular technology, such as a GSM device 16 and a GPRS device and antenna array 18. While FIG. 1 illustrates that the preferred cellular technology is the GSM 16 and the GPRS 18, due to widespread use and coverage, it will be readily appreciated that other technologies and related protocols could be employed without departing from the broader aspects of the present invention.

It will further be appreciated that GPRS is a known mobile data service available for users of GSM. GPRS can be utilized with services such as Wireless Application Protocol (WAP) access, Short Message Service (SMS), Multimedia Messaging Service (MMS), and Internet communication services such as email and World Wide Web access.

Referring again to FIG. 1, the universal tracking module 10 further includes power conditioning circuits 20 which themselves are in internal communication with a battery assembly 22 as well as a battery charging port 24, or the like. An input/output (I/O) connection means 26 is also integrated with the universal tracking module 10, to provide for audio, SIM, GPIO, serial, or other known communications and information exchanges.

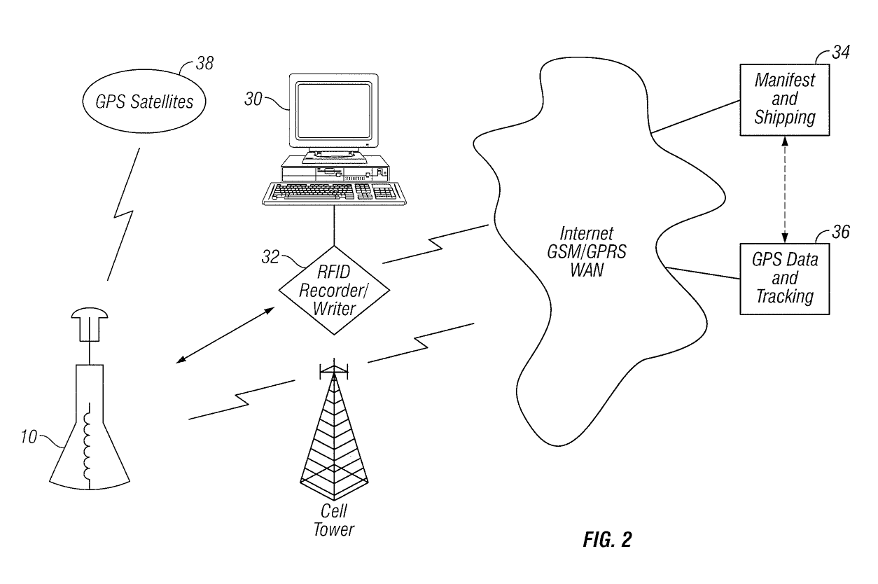

Turning now to FIG. 2, it is graphically depicted that the universal tracking module 10 is part of an overall software system used to provide for accurate tracking, status, mapping and security information as related to the tracking module 10 (and the container or vessel to which it is attached). As shown in FIG. 2, the software system is shown schematically as being part of a dedicated computer terminal 30. It will be readily appreciated that the software system of the present invention can be stored locally in machine readable format at the location of the computer terminal, or terminals, 30, or can be remotely hosted, without departing from the broader aspects of the present invention.

As illustrated graphically in FIG. 2, the software system/terminal 30 is linked with a reader/ writer 32 for the selective scanning and interrogation of the RFID device 12. The software system/terminal 30 is thereby also linked to the other interrelated elements (14/16/18/20/22/24/26) contained within the tracking module 10, so as to provide data communication on shipping and manifest information 34 relating to the container, truck, train, ship, etc that is equipped with the RFID device 12.

As also shown in FIG. 2, the software system/terminal 30 is additionally capable of acquiring GPS and tracking data 36 (via GPS satellites 38, or the like) for the interrogated RFID device 12, and may use one or more of the Internet, GSM/GPRS or WAN protocols in doing so. Such information can also be transmitted to/from the RFID device 12 via SMS protocols. In this manner, accurate position/location information can be obtained with respect to the tracking module 10.

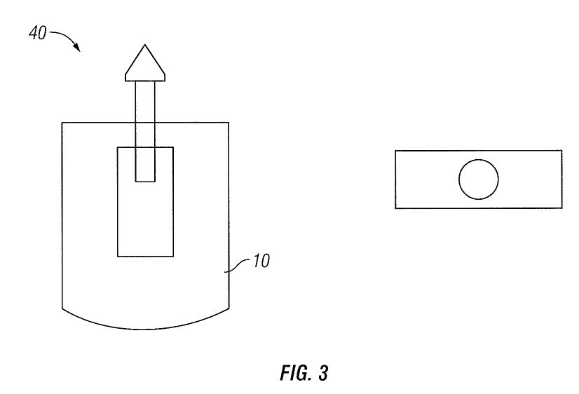

In addition to storing container information in the RFID device 12, including information on the type of item(s) stored within a container so equipped, one object of the present invention is to integrate the universal tracking module 12 with known pin-style locks, for greater functionality. FIG. 3 illustrates the universal tracking module 10 as integrated with a pin-style locking device 40. By so integrating the two components, it is possible for the RFID device 12 to store status and other ‘condition’ information relating to the pin-style-lock 40 itself, as well as storing information of the contents of a specific container to which it may be attached.

In operation, the scanning of the RFID device 12 automatically verifies that the pin-style lock 40 is valid and provides alerts if the lock has been tampered with. It will be readily appreciated that these alerts may be audible, visual, or a combination of both, as well as being transmitted by the software system and terminal 30 via Internet, GSM/GPRS, WAN or other known communication protocols (as best shown in FIG. 2). If the interrogation of the RFID device 12 indicates that the pin-style lock 40 has not be opened or otherwise tampered with, the shipping and container data is displayed from the centralized data repository, also in communication with the software system and terminal 30.

Further, if the need exists, data from US Customs AMS for Overseas Ocean and Air Shipments and associated systems for trucking and train can also be accessed. As discussed previously, the scan is linked to the central data repository via Internet, GSM/GPRS, WAN or other known communication protocols.

It is another object of the present invention is to provide a universal tracking module 10, and related system, that is capable of providing authorized users access to the exact location of a cargo shipment using the onboard GPS. The onboard GPS receives its location, which gets transmitted via GSM and GPRS. This would typically be transmitted via the Short Message Service (SMS), but can be transmitted via any available technology. Once transmitted, an individual phone, PDA, computer or web-based service, or similarly capable devices, can display the location of the shipment. The transmissions of locations are saved, in or in connection with the software system and terminal 30, to allow for the automated plotting of the route a shipment/container has taken.

The GPS device and antenna array 14 will therefore allow authorized users to query the location of the RFID device 12 on demand, to set the frequency of reporting, to review historical information, to view health/condition of the module 10, and any of the GPS data that has been recorded (such as tracking/ position information).

The tracking module 10 is also configured to allow for the addition of various sensors to be connected, via the previously discussed I/O port 26. Data from these sensors can be transmitted via the GSM/GPRS network in the same manner as the GPS data.

A Web based interface is provided for the RFID device 12, and related shipping/container data. In addition, the software system/terminal 30 can store shipment and manifest information to be available for review, also upon user authentication. A Web based interface is also available for the GPS and shipping data.

It is yet another aspect of the present invention that the software system/ terminal 30 can utilize all receive or transmitted information so as to generate a transit map of any shipping/container which is equipped with the RFID device 10. It will be readily appreciated that the software system/ terminal 30 may utilize a standard mapping program to display a historical overlay containing the tracking information of the given shipment and associated RFID device 12. It will also be readily appreciated that the computer software and terminal assembly 30 displays the historical transit map on a suitable visual display, for subsequent interaction by an authorized operator.

It is still yet another important aspect of the present invention that an authorized operator may determine historical shipment/ container information from the tracking module 10 by enabling an operator to simply ‘click’ on any data point generated by the mapping program. In doing so, an operator may ‘click’ on any data point on the generated transit map, as displayed, and thereby receive shipment/container information that was true as of the time the tracking module 10 was present at the location identified by the generated transit map.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

What is claimed is:

1. An integrated radio frequency identification system, comprising:
a locking assembly affixed to a shipping container;
a tracking module having a RFID device in electrical communication with said locking assembly, said tracking module including integrated GPS components enabling communication with GPS satellites;
a machine readable computer software and terminal assembly capable of communication with said RFID device via one of a plurality of communication protocols; and
wherein said computer software and terminal assembly is capable of generating a transit map of a location and status of said tracking module over a predetermined time period, thereby graphically depicting a historical transit path of said tracking module.

2. The integrated radio frequency identification system according to claim 1, wherein:
said plurality of communication protocols includes at least one of a GSM, GPRS, GPS, SMS and WAN protocols.

3. The integrated radio frequency identification system according to claim 1, wherein:
said historical transit path is constructed by said computer software and terminal assembly using data points generated through an interrogation of said RFID device, over said predetermined period of time.

4. The integrated radio frequency identification system according to claim 3, wherein:
said computer software and terminal assembly displays said historical transit map on a suitable visual display.

5. The integrated radio frequency identification system according to claim 4, wherein:
said computer software and terminal assembly communicates specific location information of said tracking module for each data point on said historical transit map when any of said data points on said display is specifically selected.

6. The integrated radio frequency identification system according to claim 4, wherein:
said computer software and terminal assembly communicates specific status information of said tracking module for each data point on said historical transit map when any of said data points on said display is specifically selected.

7. The integrated radio frequency identification system according to claim 6, wherein:
said specific status information includes a status of said locking assembly.

8. The integrated radio frequency identification system according to claim 7, wherein:
said computer software and terminal assembly communicates an alert when said status of said locking assembly indicates that said locking assembly has been tampered with.

9. The integrated radio frequency identification system according to claim 1, wherein:
said tracking module further comprises components capable of broadcasting information via a plurality of communication protocols including at least two of a GSM, GPRS, GPS, SMS and WAN protocols.

10. The integrated radio frequency identification system according to claim 1, wherein:
said tracking module includes an I/O port for external connection.
